(19) United States
(12) Patent Application Publication
(10) Pub. No.: US 2009/0299005 A1
(43) Pub. Date: Dec. 3, 2009

(54) Method for Inreasing the Efficiency of Surfactants, Extending the Temperature Window, and Suppressing Lamellar Mesophases in Microemulsion by Means of Additives, and Microemulsion

(75) Inventors: Juergen Allgaier, Aachen (DE); Christian Frank, Kerpen/Horrem (DE); Henrich Frielinghaus, Muenchen (DE); Dieter Richter, Juelich (DE)

Correspondence Address: JORDAN AND HAMBURG LLP, 122 EAST 42ND STREET, SUITE 4000, NEW YORK, NY, 10168, US

(73) Assignee: FORSCHUNGSZENTRUM JÜLICH GMBH, Juelich (DE)

(21) Appl. No.: 12/083,255

(22) PCT Filed: Sep. 15, 2006
(86) PCT No.: PCT/DE2006/001621

§ 371 Date: Aug. 13, 2009

(30) Foreign Application Priority Data
Oct. 18, 2005 (DE) 10 2005 049 765.9

(51) Int. Cl. C08F 2/32

(52) U.S. Cl. 524/801

(57) ABSTRACT

A method for increasing the efficiency of surfactants, broadening the temperature window, and suppressing lamellar mesophases in microemulsions by use of additives that possess at least one water-soluble unit and one hydrophobic unit are added to the microemulsions. The ratio of the number-average molecular weight of water-soluble units to the number-average molecular weight of hydrophobic units is 2 to 1000, the additives being polymers that comprise at least one water-soluble unit that possesses at least one hydrophobic unit on one chain end and/or one hydrophobic unit as a non-terminal substituent and/or at least one hydrophobic unit that is incorporated between the water-soluble units of the polymer.

### BACKGROUND OF THE INVENTION

The invention relates to a method for broadening the temperature window, increasing the efficiency of surfactants, and suppressing lamellar mesophases in microemulsions by means of additives, and relates to a microemulsion.

In accordance with the prior art, methods are known with which the efficiency of surfactants can be increased, in particular in microemulsions, but also in emulsions. Additives are added that are AB block copolymers with different A and B blocks. German patent application 198 39 054.8-41 discloses a method for increasing the efficiency of surfactants while simultaneously suppressing lamellar mesophases, a method for stabilizing the temperature of the monophase area for oil/water surfactant mixtures, a method for enlarging the structural size of emulsified liquid particles in microemulsions and a method for reducing interfacial surface tension of oil/water mixtures in which AB block copolymers with a water-soluble block A and a water-insoluble block B are added. The polymers comprise a water-soluble block A and a water insoluble block B. The lower limit for the molecular weight for A and B is 500 g/mol. This method is suitable for microemulsions.

DE 10 2004 058 956.9 describes a method for increasing the efficiency of surfactants and emulsifiers in emulsions and microemulsions by adding additives, characterized in that a polyalkylene oxide block copolymer having a water-soluble block A and an oil-soluble block B is added to the surfactant or emulsifier. The lower limit for molecular weight for A and B is 1,000 g/mol.

German patent application 10 2005 023 762.2-43 describes a method for increasing the efficiency of surfactants in microemulsions that contain silicone oil using AB block copolymers. The AB block copolymers comprise a water-soluble block A and a block B that is either a polyalkylene oxide having at least four C atoms in the monomer component or a polydiene or a partially or completely hydrogenated polydiene or polyalkane. The lower limit for molecular weight for A and B is 500 g/mol.

Publication DE 103 23 180 A1 describes mixtures containing a surfactant and a cosurfactant, characterized in that an amphiphilic comb polymer is used for the cosurfactant and has a spine and two or more side chains attached to the spine, the side chains being distinguished from one another and/or the side chains being distinguished from the spine by virtue of their amphiphilic character. The cosurfactant is suitable for increasing efficiency in microemulsions.

However, undesired lamellar mesophases frequently occur in the technical formulation of microemulsions. Lamellar mesophases can lead to optical anisotropy, increased viscosity, and phase separation.

In non-ionic, polymer-free surfactant systems, as efficiency increases the lamellar phase shifts with disproportionate strength to lower surfactant concentrations [M. Kahlweit, R. Strey, P. Firman, J. Phys. Chem., 90, 671 (1986)./R. Strey, Colloid Polym. Sci., 272, 1005 (1994).]. In efficient systems this then overlays virtually the entire monophase microemulsion. Thus the lamellar phase does not begin in the water-n-octane-triethylene glycol monooctylether system (water to n-octane ratio by volume=1) until the surfactant concentration is 34 wt. %; until the fishtail point is 20 wt. % there is a monophase microemulsion in this system. With the more efficient surfactant, pentaethylene glycol monododecyl ether, the fishtail point is attained at 5 wt %, but at the same time the lamellar phase in this system begins at 7 wt. %. Thus in this example there are only small areas of monophase microemulsions.

Existing methods for increasing efficiency are distinguished in that additives are used that have higher molecular weight polymer hydrophobic segments. This means that multi-stage processes are used during polymer production, which increases costs. Moreover, the additives are relatively difficult to degrade biologically. This is significant, especially due to the increasingly stringent legal requirements in terms of biodegradability.

In addition, the known additives are not universally employable for all oils.

There is a need to provide methods that
have additives that are simple to produce;
have constituents with the best possible biodegradability;
are universally employable so that the hydrophobic component in the additive does not have to be adapted to the oil that is used.

The method should be suitable, in particular, for hydrocarbons, silicone oils, and “polar” oils such as esters that themselves possess good biodegradability.

In addition, there is the need, while saving on surfactants, to obtain a formulation that is at least as good as with the additives that are known according to the prior art. Apart from cost considerations, saving on surfactants is also advantageous for ecological and health reasons. These requirements are particularly pronounced for silicone oil microemulsions, because the silicone surfactants used in this case are very expensive and the conventional surfactants must be employed in very high concentrations.

There can be another advantage to saving on surfactants when surfactants interfere with the application of the microemulsion. For instance, there are personal care products, the surfactant content of which should be kept as low as possible due to the harmful effects of surfactants on the skin. Other examples are microemulsions that are used to bleach films that are supposed to be very water-resistant.

It is therefore the object of the invention to provide a method for increasing the efficiency of surfactants in microemulsions. The temperature window of the microemulsion area should be broadened. Lamellar phases should be suppressed with the method and the interfacial surface tension should be reduced.

### SUMMARY OF THE INVENTION

Proceeding from the aforementioned state of the art, the object is inventively attained with the features including a polymer additive having at least one hydrophobic unit and at least one water-soluble unit added to a microemulsion, wherein a number-average molecular weight of the water-soluble units the corresponding number-average molecular weight of hydrophobic units is 2 to 1000, and each hydrophobic unit having a maximum molecular weight of 1000 g/mol.

With the inventive method and the composition it is now possible to broaden the temperature window, suppress lamellar phases, and reduce the interfacial surface tension.

The increase in efficiency is causally related to a reduction in the interfacial surface tension between water and oil and to the increase in the sizes of the water and oil domains.

Examples for the behavior of the inventively employed polymers are depicted in the figures.

### BRIEF DESCRIPTION OF THE INVENTION

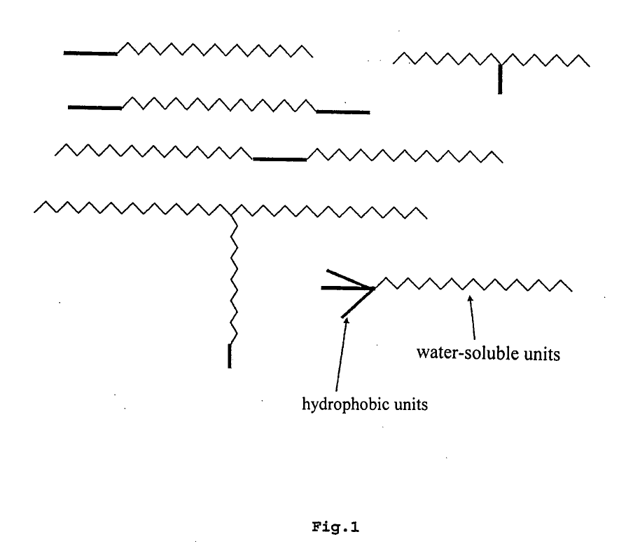

FIG. 1 depicts possible structures of the polymer additive;

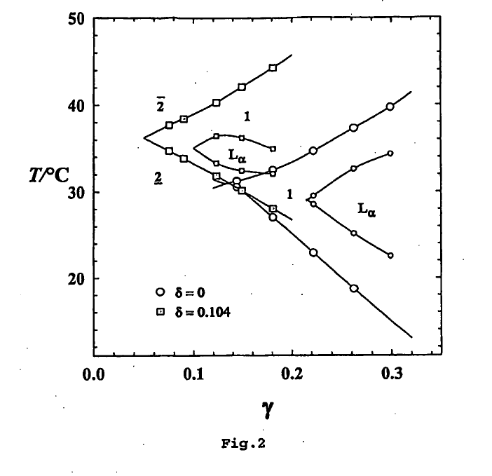

FIG. 2 depicts phase behavior of the water-n-decane-C₁₀E₄-C₁₂E₉₀ system;

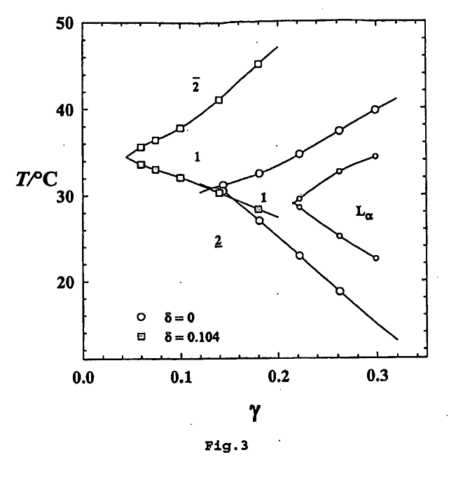

FIG. 3 depicts phase behavior of the water-n-decane-C₁₀E₄-C₁₂E₁₉₀ system;

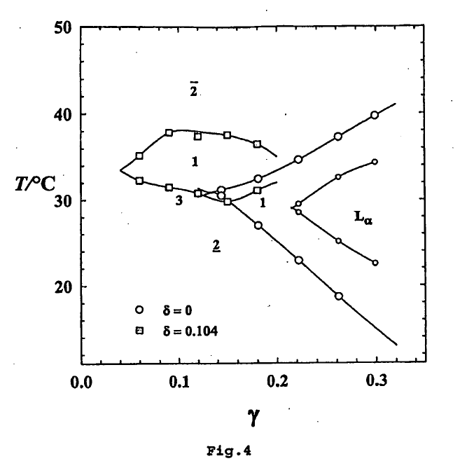

FIG. 4 depicts phase behavior of the water-n-decane-C₁₀E₄-C₁₂E₄₈₀ system;

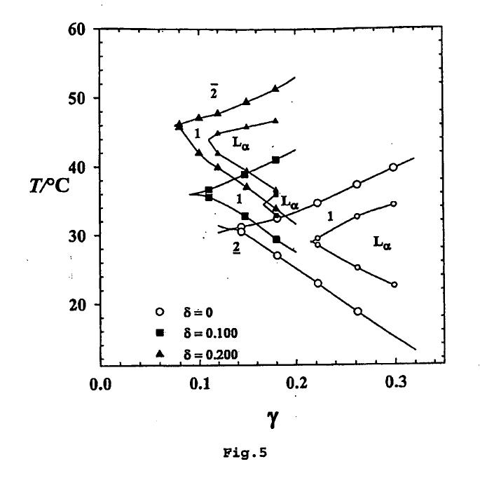

FIG. 5 depicts phase behavior of the water-n-decane-C₁₀E₄-Tergitol 15S30 system;

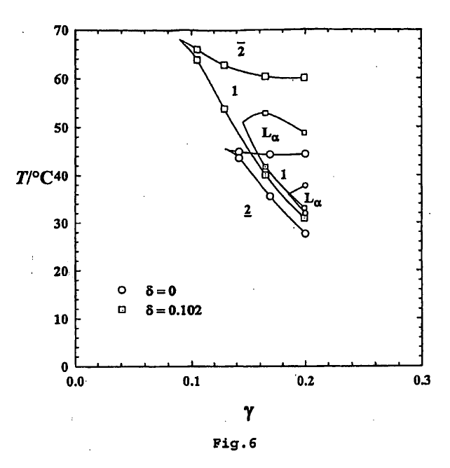

FIG. 6 depicts phase behavior of the water-hydroseal G232H-IMBENTIN AG 100/040-Brij 700 system;

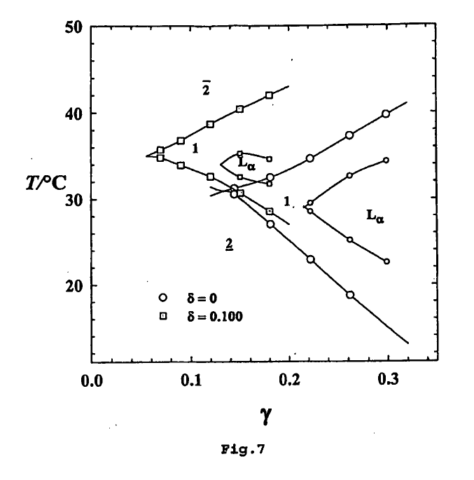

FIG. 7 depicts phase behavior of the water-n-decane-C₁₀E₄-C₁₈E₈₀ system;

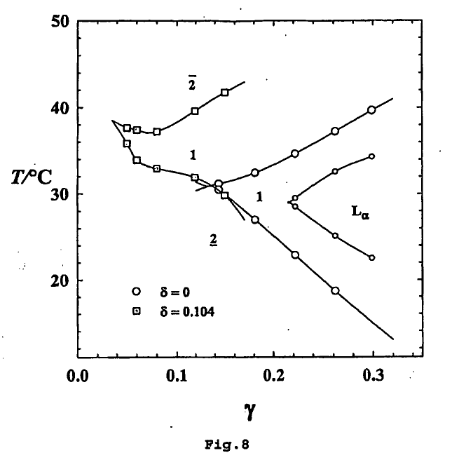

FIG. 8 depicts phase behavior of the water-n-decane-C₁₀E₄-C₁₈E₁₈₀ system;

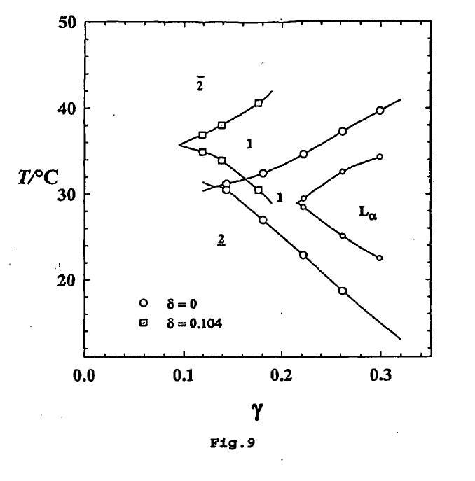

FIG. 9 depicts phase behavior of the water-n-decane-C₁₀E₄-Berol EP35 system;

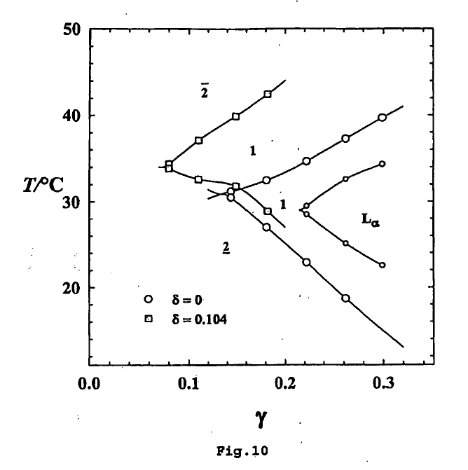

FIG. 10 depicts phase behavior of the water-n-decane-C₁₀E₄-C₈E₉₀ system;

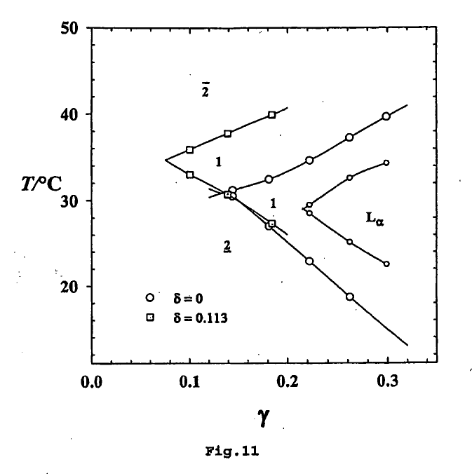

FIG. 11 depicts phase behavior of the water-n-decane-C₁₀E₄-IGEPAL DM 970 system;

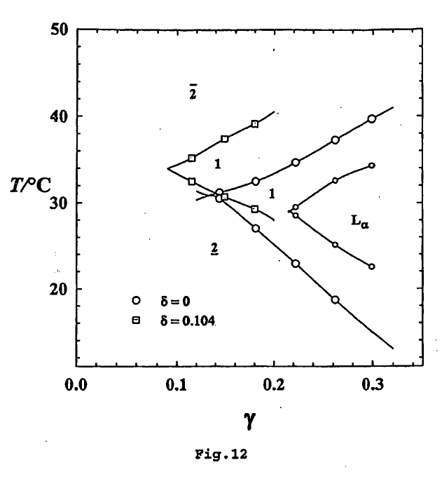

FIG. 12 depicts phase behavior of the water-n-decane-C₁₀E₄-C₁₂(E₉₀)₂ system;

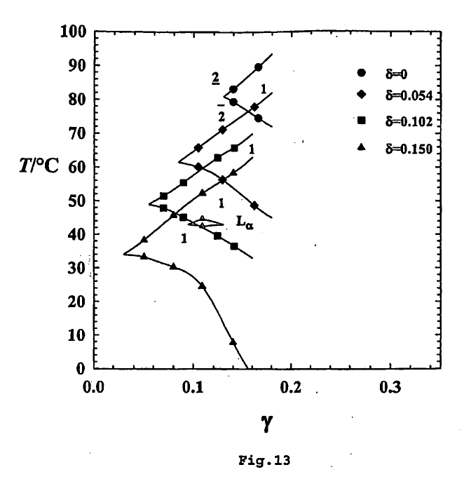

FIG. 13 depicts phase behavior of the water/NaCl-n-decane-AOT-Brij 700 system;

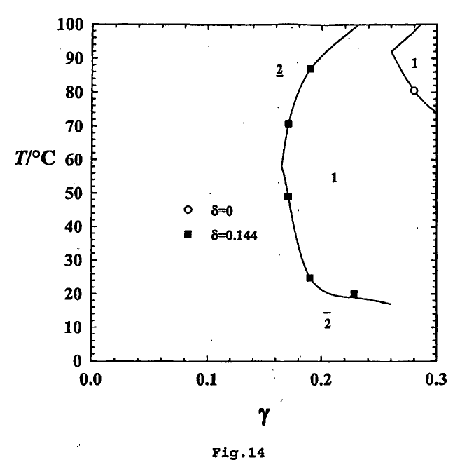

FIG. 14 depicts phase behavior of the water/NaCl-rape oil methyl ester-AOT-Brij 700 system;

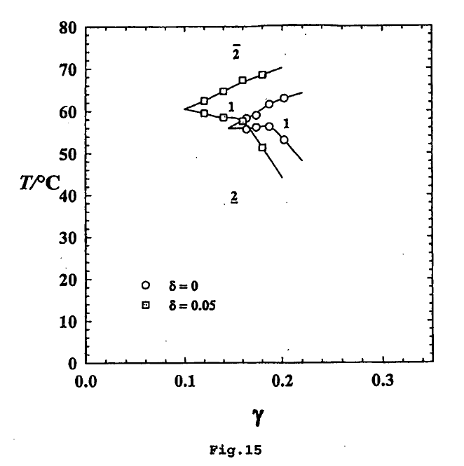

FIG. 15 depicts phase behavior of the water-MDM-C₄D₃E₈-Brij 700 system;

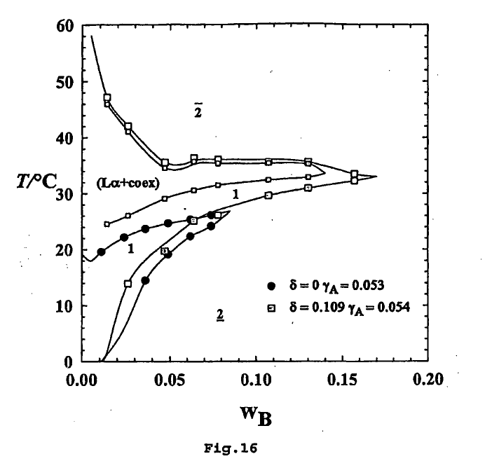

FIG. 16 depicts phase behavior of the water-n-decane-C₁₀E₄-Brij 700 system; and

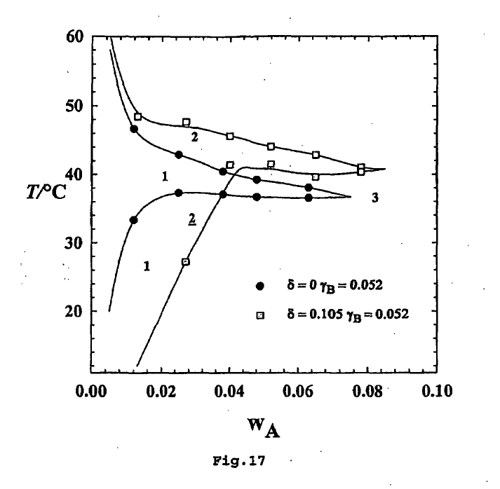

FIG. 17 depicts phase behavior of the water-n-decane-C₁₀E₄-Brij 700 system.

### DETAILED DESCRIPTION OF THE INVENTION

In accordance with the invention, for attaining the stated object polymer additives are employed that comprise at least one water-soluble unit that possesses at least one hydrophobic unit on one chain end and/or possesses one hydrophobic unit as a non-terminal substituent and/or possess at least one hydrophobic unit that is incorporated between the water-soluble units of the polymer.

The hydrophilic character is dominant in the entire polymer additive. The polymers preferably form micelles in water due to the hydrophobic unit or units.

In terms of its embodiment, the water-soluble unit of the polymer additive is not limited to specific types of structures, but rather in accordance with the invention the important aspect is the combination of the larger water-soluble unit with the hydrophobic unit or units.

The water-soluble unit of the polymer is preferably linear, but star-shaped, branched, or other structure types are also possible, as is depicted in examples in FIG. 1. For polymers, with the term “linear” it is understood that the atoms that form the spine of the chain represent a linear unit. FIG. 1 depicts the hydrophobic units with bolded lines and the water-soluble units with the zig-zag lines.

The water-soluble unit can be non-ionic or ionic, that is, a polyelectrolyte. The electrical charges can be disposed on any part of the water-soluble component of the polymer. Structures are also conceivable that constitute at least one ionic and one non-ionic portion.

As an example, but not limiting of the invention, the water-soluble units can comprise the following monomers or mixtures of at least two components thereof: ethylene oxide, vinyl pyrrolidine, acrylic acid, methacrylic acid, maleic acid anhydride, or acrolein.

The water-soluble part of the polymer additive is preferably a polyethylene oxide or polyethylene glycol. Additional examples are copolymerisates of ethylene oxide and propylene oxide, polyacrolein, polyvinyl alcohol and its water-soluble derivatives. Also suitable are polyvinyl pyrrolidone, polyvinyl pyridine, polymaleic acid anhydride, polymaleic acid, polyacrylic acid, polymethacrylic acid, polystyrene sulfonic acid and its water-soluble salts.

The water-soluble units are preferably linear.

The molecular weight distribution of the water-soluble unit, defined by the ratio of the weight-average molecular weight and the number-average molecular weight, is preferably ≦1.2.

The number-average molecular weight of the water-soluble unit of the polymer additive is preferably between 500 and 100,000 g/mol, better 2000 to 20,000 g/mol, particularly preferred between 3000 and 10,000 g/mol.

Similar to the water-soluble part of the polymer additive, the embodiment of the hydrophobic unit is not limited to specific structure types. On the contrary, what is important here is merely the hydrophobic or non-water-soluble properties of this unit.

Preferred molecule sizes for the hydrophobic unit are 80 to 1000 g/mol, particularly preferred 110 to 500 g/mol, especially preferred 110 to 280 g/mol.

The hydrophobic units comprise non-water-soluble groups. These are preferably alkyl groups that preferably contain between 6 and 50 carbon atoms, particularly preferred between 8 and 20 carbon atoms. The groups can also contain aromatic groups or carbon double or triple bonds, and they can be linear or branched. Apart from hydrocarbon groups, other desired organic hydrophobic groups can be used that contain for instance oxygen, nitrogen, fluorine, or silicon atoms. The hydrophobic unit can also be a polymerisate.

The hydrophobic unit can be a group with a defined structure and molecular weight, such as for instance alkyl groups. Mixtures that occur for instance in technical products are also possible. However, it can also be a polymer group such as polybutylene oxide.

The water-soluble unit of the polymer bears a hydrophobic unit on at least one chain end.

More than one hydrophobic unit are also possible at each chain end.

The water-soluble unit of the polymer can bear a hydrophobic unit in a non-chain end position.

Furthermore, hydrophobic units of the polymer additive can be incorporated at least one location between the water-soluble units so that the water-soluble units of the polymer are interrupted by hydrophobic units.

All combinations of the structure types presented are possible.

The ratio of molecular weight of the water-soluble part to that of the hydrophobic part is 2-1000, preferably 5-500, particularly preferred 10-50.

In the preferred form the water-soluble unit of the additive is a linear polymer and bears a hydrophobic unit on one chain end.

The following inventive polymer additives are provided as examples:
alkyl ethoxylates obtained by ethoxylation of C₈-C₂₀ alcohols;
alkyl ethoxylates obtained by ethoxylation of C₁₀-C₂₀ 1,2 diols;
alkyl ethoxylates obtained by ethoxylation of C₈-C₂₀ α, ω diols;
hydrophobically modified polyethylene glycol at both chain ends that can be obtained e.g. by reacting polyethylene glycol with C₈-C₂₀ isocyanates or C₈-C₂₀ acid chlorides;
AB diblock copolymers, ABA or BAB triblock copolymers from 1,2 butylene oxide and ethylene oxide.

The additives preferably form micelles in water due to the hydrophobic units.

In one embodiment a hydrophobic unit is disposed at each end of the water-soluble unit.

Linear water-soluble polymers that bear a hydrophobic unit on only one chain end are preferred for inventive additives. Within this structure type, alcohol ethyoxylates that possess a high degree of ethoxylation are preferred. These substances can be considered polyethylene oxide having a hydrophobic alkyl group or long-chain or hydrophilic emulsifiers. For instance, aliphatic alcohols or alkylphenols that preferably possess 8-20 carbon atoms can be used for hydrophobic components. The alcohol ethoxylates preferably contain 25 to 500 mol ethylene oxide per mol of alcohol, particularly preferred 50-200 mol ethylene oxide per mol of alcohol. One example is the commercially available compound Brij 700 from Uniqema.

The portion of water-soluble units that are not linked to hydrophobic units should be as small as possible in the polymer additive, that is for instance ≦20 wt. %.

For example, but not limiting to the invention, the following surfactants and mixtures thereof can be used with the inventive additives:

Non-ionic surfactants of the alkoxylated alcohols class, e.g. alkyl ethoxylates, also those with a narrow molecular weight distribution and/or a low residual alcohol content, alkylphenol ethoxylates;

Sorbitan ester and ethoxylated sorbitan ester;

Non-ionic surfactants from the alkyl polyglucosides class (APG, “sugar surfactants”) having a hydrophobic cosurfactant;

Silicon polyether surfactants;

Anionic surfactants, e.g. alkyl sulfates, alkyl sulfonates, alkylbenzene sulfonates, alkylether sulfates, sulfosuccinates, alkylether carboxylates, phosphates, and carboxylic acid salts. The anionic surfactants are preferably used in the form of their Li⁺, Na⁺, K⁺, or ammonium salts;

Cationic surfactants, e.g. tetraalkyl ammonium compounds;

Amphoteric surfactants, e.g. sulfobetaines, betaines, amphoacetates, amphopropionates;

Mixtures of surfactants, in particular, non-ionic/anionic or non-ionic/cationic or silicone surfactant having non-silicon-containing surfactant.

The inventively used polymer additive can have the same structure type as the surfactants used in the microemulsion, but the molecular weight of the hydrophilic water-soluble unit of the polymer additive must be greater than the molecular weight of the hydrophilic component of the surfactant. It is preferred when the molecular weight of the water-soluble unit of the polymer additive is at least 2 times that of the hydrophilic component of the surfactant, particularly preferred at least 5 times or at least 10 times that of the hydrophilic component of the surfactant.

The aqueous phase of the microemulsion can contain additives such as salts or water-soluble organic compounds such as, e.g., glycols.

The oil phase can also contain additives, but the additives should not destroy the microemulsion.

For instance glycerin can be added to the water in order to adjust the refractive index of the aqueous component to that of the oil component. Because of this, microemulsions that are visually cloudy, and the efficiency of which has been increased, become transparent again. This method is particularly significant for microemulsions that are used in the fields of cosmetics, hair care products, and personal care products.

The inventive microemulsions do not absolutely have to be liquid. They can also include a gel-like solid mixture provided it is a microemulsion in the thermodynamic sense. The solid form can therefore be obtained, e.g., by adding additives to the aqueous and/or oily component or by using the mesophases present in the microemulsion.

The microemulsion can become solid at low temperatures, e.g., due to the oil phase solidifying.

The volume ratio of aqueous phase to oil phase is for instance 0.01-100, preferably 0.1-10 or 0.3-3.

The polymer additive portion by weight in the surfactant/additive mixture is for instance preferably 0.01-0.3, particularly preferred 0.05-0.15.

The surfactant/additive mixture portion by weight in the microemulsion is preferably 0.01-0.3, particularly preferred 0.05-0.2. Frequently a higher surfactant/additive mixture portion by weight is needed in the microemulsion for larger temperature windows.

The invention also includes microemulsions with the substance features of the disclosure that are characterized in that the microemulsions contain a polymer additive, wherein the ratio of the weight of polymer additive to surfactant+additive is ≦0.2 and the ratio of the weight of surfactant+polymer additive to oil is ≦0.5.

Moreover, it is preferred when these microemulsions are characterized in that the ratio of the weight of polymer additive to surfactant+polymer additive is ≦0.15 or ≦0.10.

It is particularly preferred when the ratio of the weight of surfactant+polymer additive to oil is ≦0.33.

Additional microemulsions that contain the polymer additives contained in the disclosure are characterized in that the ratio of the weight of polymer additive to surfactant and polymer additive is ≦0.2 and in that the polymer additive possesses one or more hydrophobic units at one location in the molecule.

In this context, it is advantageous when the ratio of the weight of polymer additive to surfactant and polymer additive is ≦0.15 or ≦0.10. It is furthermore preferred when the ratio of the weight of surfactant+polymer additive to oil is ≦1 or when the ratio of the weight of surfactant+polymer additive to oil is ≦0.5, preferably ≦0.33.

The increase in efficiency, broadening of the temperature window, and suppression of lamellar phases are a function of the polymer additive portion by weight in the surfactant/additive mixture and of the molecular weight of the water-soluble units.

As a rule, the increase in efficiency rises as the polymer additive portion by weight increases in the surfactant/additive mixture and as the molecular weight of the water-soluble units increases. However, the rise in the increase in efficiency as molecular weight increases becomes smaller starting with molecular weights that can be between 4000 and 20,000 g/mol per water-soluble unit, depending on the case.

As a rule, the broadening in the temperature window increases as the polymer additive portion by weight in the surfactant/additive mixture increases and as the molecular weight of the water-soluble units increases. However, as molecular weight increases the increase in the broadening of the temperature window becomes decreases starting with molecular weights that can be between 4000 and 20,000 g/mol per water-soluble unit, depending on the case. This is especially true for higher surfactant concentrations.

As a rule, the suppression of lamellar phases rises as the polymer additive portion by weight increases in the surfactant/additive mixture and as the molecular weight of the water-soluble units increases. However, the suppression decreases when the polymer additive portion by weight in the surfactant/additive mixture exceeds values that are between 15% and 25%.

The aforesaid values apply as a rule. However, there can be deviations that are a function of the polymer additive, surfactant, oil, or other additives used.

When the ratio of water to oil is high there are preferably oil-in-water drop-shaped microemulsions.

When the ratio of water to oil is low, there are preferably water-in-oil drop-shaped microemulsions.

When the ratio of water and oil is balanced there are preferably bicontinuous microemulsions.

In accordance with the invention the efficiency of the surfactant mixture is significantly increased, the temperature window is broadened, and lamellar mesophases are suppressed in microemulsions, and the interfacial surface tension is reduced by adding the inventive polymer additives to the water/oil/surfactant mixture. In addition, microemulsions retain the properties characteristic of them while expanding their structure size; thus the emulsified structures have sizes of up to approx. 2000 Angstroms. The size of the emulsified liquid particles is largely a function of the surfactant concentration.

The temperature of the monophase area is changed by the inventive polymer additives. Surprisingly, the change can be predicted. When using non-ionic surfactants, the monophase area is shifted to higher temperatures; when using ionic surfactants, as a rule there is a change to lower temperatures. The desired temperature range can be set by selecting appropriate surfactants.

A few terms shall be defined in the following:

Microemulsions are understood to be mixtures that include water, oil, surfactant, and any additives in the aqueous and/or oil phase, and that are thermodynamically stable.

Oil is understood to be a liquid that is not miscible with water. This can be gases that are liquifiable under pressure or supercritical liquids that are gaseous at normal pressure. The invention also includes microemulsions under increased pressure.

Frequently hydrocarbon oils are used as oils in microemulsions. However, microemulsions having other oils such as ester oils or silicone oils are also known that can be employed for the inventive method.

The efficiency of the surfactants is expressed in the quantity of surfactant that is required in order to create a specific portion of oil in water or vice versa in the form of a microemulsion. Efficiency is quantified in the minimum surfactant concentration that is needed to obtain a monophase microemulsion. The point in the phase diagram that is characterized by the minimum surfactant concentration and the associated temperature is called the fishtail point.

Increase in efficiency means that the fishtail point is shifted to smaller total surfactant concentrations by the addition of the inventive polymer additive. There is also an increase in efficiency when a surfactant or surfactant mixture does not form a microemulsion but a microemulsion is produced by adding the inventive polymer additive.

Broadening the temperature window is understood to mean that, at the same total surfactant concentration, the temperature range in which a monophase microemulsion exists is larger due to the addition of the inventive polymer additive than without the polymer additive.

Suppressing lamellar phases is understood to mean that, relative to the fishtail point, the expansion of the lamellar phase on the surfactant concentration axis and on the temperature axis in the phase diagram is smaller for a microemulsion with the polymer additive than for the comparable microemulsion without the polymer additive.

The interfacial surface tension between water and oil is reduced with the inventively employed polymer additives. The occurrence of lamellar mesophases is suppressed. The efficiency of microemulsions is increased and the temperature window within which the microemulsion is stable is broadened.

Among possible applications are hair and personal care products and cosmetic products such as deodorants, skin care products, sunscreens, lotions, shampoos, shower gels, bath preparations, lubricants, slip agents, release agents, plant protection products, pharmaceuticals, foods, food additives, textile care products, leather and fur care products, automobile care products, cleaners and polishes, products for household, commercial, and industrial applications, hydraulic fluids, disinfectants, paints and dyes, building materials, printer inks, explosives, and detergents for household, commercial, and industrial use. It is also possible to produce microemulsions, the sizes of which correspond to those of the emulsified liquid particles in emulsions. The temperature window for the stability of the microemulsions should be enlarged for the same surfactant content if silicone oils are added.

The inventive microemulsions can also be used as reaction media, they can absorb hydrophobic impurities or form by absorbing hydrophobic impurities, for instance when used as washing agents or detergents. The inventive microemulsions can also give off hydrophobic components and/or wet solid or liquid surfaces. The inventive microemulsions can also be present in the form of concentrates that are still microemulsions after dilution, for instance with water. The inventive microemulsions can also be two or three-phase systems, a microemulsion phase coexisting with an excess oil and/or water phase. However, by adding the inventive additive the portion of the microemulsion phase is increased relative to the mixture without additive.

The microemulsions can be produced with adding a great deal of energy. The components can be mixed in any sequence, wherein it is advantageous to pre-dissolve the polymer in water or add it directly to the water/oil surfactant mixture due to generally good water solubility.

The inventively employed polymer additive can also be prepared as a mixture with a surfactant.

The microemulsions produced by means of the inventive addition of the water-soluble polymers have emulsified liquid volumes that can be the same as those of emulsions.

An expansion in the temperature interval within which the microemulsion is thermodynamically stable is associated with the increase in efficiency. This is particularly advantageous for technical applications where there must be stability across large temperature ranges.

Advantages of the additives include the following:
The polymer additives can already be obtained commercially and can be produced cost-effectively. In their simplest embodiment they are high ethoxylated alcohols. One example is Brij 700 (Uniqema);
As a rule they are more biodegradable than polymers that contain long-chain hydrophobic segments. This is especially important with respect to the increasingly stringent legal requirements regarding degradability;
The polymer additives have good water-solubility and can be dissolved with no problem in aqueous precursors for the microemulsion;
The polymer additives are universally employable, i.e., can be used regardless of the chemical structure of the oils. Thus, the same additive can be employed in microemulsions that contain very different oils. For additives that contain higher molecular weight polymer units for hydrophobic components, however, more attention must be given to the compatibility of the hydrophobic additive components with the oil. For instance, only block copolymers that contain certain hydrophobic blocks are suitable for microemulsions that contain silicone oil for the oil.

The aforesaid advantages also largely apply for polymer additives that are present as block copolymerisates, since the hydrophobic units are short-chained.

The inventively employed water-soluble polymers are suitable for bicontinuous, water-in-oil and oil-in-water microemulsions. They are suitable for microemulsions that contain hydrocarbons for the oil component, but they are also suitable for microemulsions that contain polar oils such as ester oils, silicone oils, or supercritical liquids for the oil component.

The polymer additives are particularly suitable for microemulsions having ionic surfactants that form monophase areas at very high temperatures. Adding the polymer additive broadens the temperature range of the monophase area and reduces the temperature range to lower temperatures. The additives are also particularly suitable for microemulsions having hydrophobic non-ionic surfactants, such as for instance low-ethoxylated alcohols. These surfactants form microemulsions at very low temperatures. Adding the additive shifts the temperature range of the monophase area to higher temperatures and also broadens it. The temperature range of the monophase area can be shifted, both for the ionic surfactants and for the hydrophobic non-ionic surfactants, such that it is of greater interest for applications.

### EXAMPLES

The polymer additives used for the examples, C₈E₉₀, C₁₂E₉₀, C₁₂E₁₉₀, C₁₂E₄₈₀, C₁₈E₈₀, C₁₈E₁₈₀ C₁₂(E₉₀)₂, were produced by ethoxylation of the underlying alcohols. Used for alcohols were: 1-octanol for C₈E₉₀; 1-dodecanol for C₁₂E₉₀, C₁₂E₁₉₀ and C₁₂E₄₈₀; 1-octadecanol for C₁₈E₈₀ and C₁₈E₁₈₀; 1,2-dodecanediol for C₁₂(E₉₀)₂. All of the alcohols are linear, unbranched alcohols.

The polymer additives C₈E₉₀, C₁₂E₁₉₀, C₁₂E₁₉₀, C₁₂E₄₈₀, C₁₈E₈₀, C₁₈E₁₈₀ C₁₂(E₉₀)₂ were characterized by means of gel permeation chromatography (GPC). Number-average molecular weights Mn and molecular weigh distributions Mw/Mn of the polymer additives were calculated with a calibration curve that was obtained by means of the polyethylene glycol standard.

The measured values for Mw/Mn were all less than 1.1. The following table provides the measured molecular weights. Also provided are the molecular weights of the hydrophobic units (M(hydrophobic)) calculated from the empirical formulas of the alcohols and the number-average molecular weights of the water-soluble units (Mn (water-soluble)) that were calculated from the difference between Mn (GPC) and M (hydrophobic). The degree of ethoxylation was obtained from (Mn (water-soluble) by dividing by 44 (molecular weight of one ethylene oxide unit).

TABLE 1

| | | | Mn(water- | Degree of |
|---|---|---|---|---|
| | Mn(GPC) | M(hydrophobic) | soluble) | ethoxylation |
| C₈E₉₀ | 4130 | 113 | 4020 | 91 |
| C₁₂E₉₀ | 4270 | 169 | 4100 | 93 |
| C₁₂E₁₉₀ | 8490 | 169 | 8320 | 189 |
| C₁₂E₄₈₀ | 21200 | 169 | 21000 | 477 |
| C₁₈E₈₀ | 3880 | 253 | 3630 | 82 |
| C₁₈E₁₈₀ | 8020 | 253 | 7770 | 176 |
| C₁₂(E₉₀)₂ | 8180 | 169 | 8010 | 91 × 2 |

Moreover, the following additional polymer additives were used:

Berol EP 35 (Akzo Nobel Surface Chemistry AB). This is a C8 alcohol ethoxylate with an average 35 ethylene oxide units per molecule (information from manufacturer). Calculated from the chemical structure, the mean molecular weight for the hydrophobic unit is 113 g/mol and for the water-soluble unit is 1560 g/mol.

Tergitol 15-S-30 (Union Carbide). This is a C11-15 alcohol ethoxylate with an average of 30 ethylene oxide units per molecule (Handbook of Industrial Surfactants, 2nd Edition, Gower Publishing, ISBN 0-566-07892-9). Calculated from the chemical structure, the average molecular weight for the hydrophobic unit is 180 g/mol and for the water-soluble unit is 1340 g/mol.

Brij 700 (Uniqema). This is a stearyl alcohol ethoxylate with an average of 100 ethylene oxide units per molecule (information from manufacturer). Calculated from the chemical structure, the mean molecular weight for the hydrophobic unit is 250 g/mol and for the water-soluble unit is 4400 g/mol.

Igepal DM 970 (Rhône-Poulenc). This is a dinonyl phenol ethoxylate with an average of 150 ethylene oxide units per molecule (Handbook of Industrial Surfactants, 2nd Edition, Gower Publishing, ISBN 0-566-07892-9). Calculated from the chemical structure, the mean molecular weight for the hydrophobic unit is 330 g/mol and for the water-soluble unit is 6600 g/mol.

For all of the polymer additives described here except for C₁₂(E₉₀)₂, the structure type is a linear water-soluble polymer chain that is provided with one hydrophobic unit on one end. For the polymer additive C₁₂(E₉₀)₂, the structure type is a linear water-soluble polymer chain that is provided with one hydrophobic unit in the middle of the chain.

The following surfactants and oils were used for the examples: tetraethylene glycol monodecylether (C₁₀E₄); IMBENTIN AG 100/040, C10 alcohol ethoxylate with an average of 4 ethylene oxide units (information from manufacturer) (Kolb, Switzerland); Hoesch T5 Isotridecanolat with an average of 5 ethylene oxide units (Julius Hoesch GmbH & Co. KG, Düren); sodium bis(2-ethylhexyl) sulfosuccinate (AOT); hydroxy(polyethyleneoxy)propyl-terminated polydimethyl siloxane molecular weight 550-650 g/mol 50% (CH₂—CH₂—O) (MCR-C13, Gelest Inc. Morrisville, Pa., USA) (C₄D₃E₈); n-decane; octamethyl trisiloxane (MDM); Hydroseal G232H, mixture of C₁₃-C₁₅ aliphatic hydrocarbons, boiling range 235-265° C., flame point 102° C. (Julius Hoesch GmbH & Co. KG, Düren); rape oil methyl ester (Biodiesel/ADM-Oelmühle Hamburg AG/ADM Oelmühle Leer Connemann GmbH+Co. KG).

Provided there is no information given to the contrary, the temperature concentration (T/γ) phase diagrams shown in FIGS. 2-17 relate to systems with a constant water/oil volume ratio of 1:1 (φ=0.5) and shall be explained in the following.

Several terms are introduced in the following:

C=any desired surfactant or emulsifier, such as an anionic, cationic, non-ionic, or sugar surfactant, and mixtures that contain at least two surfactants.
D=additive that is inventively added to the surfactant C;
γ=total surfactant concentration (weight fraction) of C and D where

$$γ = \frac{m ( C ) + m ( D )}{{m}_{tot}}$$

where
m=mass in g
γ=dimensionless weight fraction
mₜₒₜ=total mass from m_{water}+mₒᵢₗ+m(C)+m(D)
δ=weight fraction of the additive D in the mixture surfactant C+additive D, equals

$$δ = \frac{m ( D )}{m ( C ) + m ( D )}$$

where m=mass in g and
δ=weight fraction (dimensionless).

In the diagrams, the curves are plotted for each δ value that characterizes the limit of the respective monophase area belonging to the δ value. The point in each curve is the fishtail point. The label 1 characterizes the areas of monophase microemulsion, 2 describes an oil-in-water microemulsion in coexistence with an oil phase, and 2̅ describes a water-in-oil microemulsion in coexistence with a water phase. In the figures, lamellar phases are labeled L_{α}, and if this symbol is not shown then no lamellar phases occur in the area investigated. The following phase diagrams each provide the expansion of the microemulsion phase as a function of surfactant concentration γ and temperature T.

FIG. 2 depicts how the efficiency of the monophase microemulsion increases in the water-n-decane-C₁₀E₄ system when the polymer C₁₂E₉₀ is added. If 10% of the surfactant is replaced with C₁₂E₉₀ (δ=0.10), the fishtail point shifts from γ=0.13 to γ=0.05, i.e. the surfactant required for solubilization is reduced by more than half. In this example, the formation of a low-viscosity lamellar phase is linked to the increase in efficiency. The area of the lamellar phase only covers a small part of the mono-phase area, however. Although it would be expected that nearly the entire microemulsion area should be filled with the lamellar phase due to the increase in efficiency. Relative to the fishtail point, the expansion of the lamellar phase on the temperature axis is even more limited than in the surfactant system without the polymer addition. The breadth of the temperature window for the microemulsion phase increases sharply and due to the polymer addition the temperature of the fishtail point shifts to a temperature that is only slightly higher. Overall the temperature of the fishtail point is increased by about 5-7° C.

The efficiency of the total surfactant is also increased in the water-n-decane-C₁₀E₄ system depicted in FIG. 3 with the addition of the polymer additive C₁₂E₁₉₀. The increase in efficiency and the expansion of the monophase microemulsion is slightly better than in the system illustrated in FIG. 2. However, selecting the larger polymer C₁₂E₁₉₀ effectively suppresses the formation of the lamellar phase in the area investigated.

FIG. 4 depicts the increase in efficiency of the polymer additive C₁₂E₄₈₀ in the water-n-decane-C₁₀E₄ system. In this example, the increase in efficiency is slightly better, in terms of the position of the fishtail point, than in the water-n-decane-C₁₀E₄-C₁₂E₉₀ or water-n-decane-C₁₀E₄-C₁₂E₁₉₀ systems depicted in FIG. 2 and FIG. 3, respectively. However, the broadening of the temperature window at γ≧0.10 is less pronounced than in the systems depicted in FIGS. 2 and 3. The larger hydrophilic polymer prevents the formation of a lamellar phase in this case, as well, however.

Polymers with smaller hydrophilic blocks can also be used, however, as is illustrated in FIG. 5 with the water-n-decane-C₁₀E₄-Tergitol 15S30 system. In this example the polymer-free system (δ=0) is compared to the system with 10% polymer additive (δ=0.100) and to the system with 20% polymer additive (δ=0.200) in the surfactant mixture. Although the increase in efficiency is less than in the previous examples, a clear expansion is obtained in the microemulsion area, especially at δ=0.200. However, this is connected to an increase of approximately 15° C. in the temperature range for the microemulsion compared to the polymer-free system. While the lamellar phase remains nearly constant relative to the fishtail point for δ=0.100 compared to the polymer-free system, for δ=0.200 the lamellar phase is much more pronounced.

In FIGS. 6-8 a more hydrophobic C₁₈ hydrocarbon group is used instead of a C₁₂ group.

FIG. 6 depicts the water-Hydroseal G232H-IMBENTIN AG 100/040-Brij 700 system at δ=0 and δ=0.102. The fishtail point shifts from γ=0.12 to γ=0.08. The temperature window is considerably broadened and the phase inversion temperature of T=44° C. increases to T=68° C. This increase in temperature can also be used to obtain more hydrophobic but efficient surfactants in the desired temperature range. Thus fewer ethoxylated surfactants have a microemulsion area that is at lower temperatures than comparable higher ethoxylated surfactants that have the same hydrophobic group. In addition, low-ethoxylated surfactants are slightly more efficient than higher ethoxylated surfactants. It can therefore make sense to use a surfactant that is ethoxylated too low for the desired temperature range and to increase the temperature range using the polymer additive.

In this example the formation of a low-viscosity lamellar phase is connected to the increase in efficiency in the water-Hydroseal G232H-IMBENTIN AG 100/040-Brij 700 system. Due to the pronounced increase in efficiency, it would have been expected that nearly the entire microemulsion area is filled with the lamellar phase.

FIG. 7 depicts the effect of a larger, more hydrophobic group in the C₁₈E₈₀ polymer on the phase behavior of the water-n-decane-C₁₀E₄ system. The phase behavior and the increase in efficiency is comparable to the water-n-decane-C₁₀E₄-C₁₂E₈₀ system depicted in FIG. 1. In this example, as well, the formation of a low-viscosity lamellar phase, which is even less pronounced relative to the fishtail point than in the system without polymer, is connected to the increase in efficiency. In this case, as well, it would be expected that due to the increase in efficiency nearly the entire microemulsion area would be filled with the lamellar phase.

In FIG. 8 the complete suppression of the lamellar phase is attained in the water-n-decane-C₁₀E₄-C₁₈E₁₈₀ system. The fishtail point for the system that contains polymer (δ=0.104) is at γ=0.03 and is thus less than in the polymer-free system (δ=0) by a factor of 4.

Hydrophobic groups smaller than C₁₂ can also be used for hydrophobic units in the inventive polymer additives. This is depicted in FIG. 9. The efficiency of the water-n-decane-C₁₀E₄ system is increased with the addition of 10% (δ=0.104) Berol EP35 without forming lamellar phases that are frequent in the efficient surfactant system. The temperature window is also broadened.

FIG. 10 depicts the increase in efficiency in the water-n-decane-C₁₀E₄ system when the polymer C₈E₉₀ is added. When 10% of the surfactant is replaced with C₈E₉₀, the total surfactant requirement drops from γ=0.13 to γ=0.07. The temperature expansion of the monophase microemulsion increases by the same measure; there is no lamellar phase in the system investigated.

FIG. 11 depicts how the efficiency of the total surfactant increases with the addition of the polymer IGEPAL DM970 to the mixture of water-n-decane-C₁₀E₄ at δ=0.113. Again there are no lamellar phases in the microemulsion with the polymer added. In this system, as well, the phase inversion temperature is shifted about 5° C. higher. As in the foregoing examples, a constant water/oil ratio, φ=0.5, was used.

FIG. 12 depicts how the total surfactant quantity required drops with the addition of the polymer C₁₂(E₉₀)₂ to the mixture of water-n-decane-C₁₀E₄ at δ=0.104. The phase inversion temperature shifts upward only slightly, by about 4° C.; the basic phase behavior remains unchanged by the addition of the polymer. No lamellar phase occurs in the range examined.

There is an even more pronounced broadening of the temperature window and increase in the efficiency when the inventive polymer additive is used with the ionic surfactant AOT. FIG. 13 depicts this in the water/NaCl (1%)-n-decane-AOT-Brij 700 system as a function of different polymer concentrations δ. As the polymer addition δ increases, the phase inversion temperature drops such that reaches a range suitable for most applications, while without polymer additives microemulsions occur in the less interesting temperature range. At the same time, as the polymer portion increases the minimum surfactant requirement drops and the breadth of the monophase microemulsion is clearly enlarged. Even at δ=0.15 there is only a minimal lamellar island.

The new polymer class is also very well suited for microemulsions having polar oils such as ester oils. This is depicted in FIG. 14 with the water/NaCl (1%)-rape oil methyl ester-AOT-Brij 700 system. In the polymer-free system (δ=0), only one measuring point could be found; the actual microemulsion area is approximately the range shown, however, and is at about 90° C. Even with a high surfactant portion, 28%, the lower phase limit is 80° C. When 14% of the surfactant is replaced with Brij 700 (δ=0.144), the microemulsion area obtained is between 20° C. and 80° C. with a surfactant portion less than 20%. The use of rape oil methyl ester as the oil component is possible at low surfactant concentrations only with the use of the polymer Brij 700. When a non-ionic surfactant such as Hoesch T5 is used instead of the inventive polymer additive, no monophase microemulsion phase forms.

Silicone oils are also suitable for the oil component of microemulsions. FIG. 15 depicts how the efficiency of the total surfactant and the temperature window enlarge with the addition of the polymer Brij 700 in the mixture of water-MDM-C₄D₃E₈ at δ=0.05. The minimum surfactant requirement shifts in the system from γ=0.14 to γ=0.10 with Brij 700 in the surfactant mixture (δ=0.05). The needed total surfactant portion is reduced by about 30%. No lamellar phase occurs in the investigated system.

The efficiency-increasing effect of the new polymer class can also be observed in systems having small oil portions. FIG. 16 depicts an o/w microemulsion in the mixture of water-n-decane-C₁₀E₄-Brij 700. The constant surfactant/water ratio γ_{A} is 0.053, the oil portion W_{B} in the total mixture is varied as a function of the temperature in this plot. In the polymer-containing system (δ=0.109), significantly greater portions of oil can be solubilized than in the polymer-free system. The weight fraction of the maximum oil portion W_{B} is increased from W_{B}=0.07 to W_{B}=0.18. In addition to the increase in efficiency, there is also a pronounced broadening of the temperature window. In the polymer-containing system (δ=0.109), a lamellar phase occurs, but an expansion thereof is not as great as would be expected based on the efficiency.

FIG. 17 depicts the efficiency-increasing effect of the new polymer class in w/o microemulsions having small water portions. The constant surfactant/oil ratio γ_{B} is 0.052, the water portion W_{A} in the total mixture of water-n-decane-C₁₀E₄-Brij 700 is varied as a function of the temperature in this plot. When 10% of the surfactant is replaced with Brij 700, the temperature window of the monophase microemulsion clearly enlarges and the efficiency of the system increases. No lamellar phases occur in the system investigated.

1.-45. (canceled)

46. A method for effecting at least one change in at least one behavioral characteristic of a microemulsion, comprising:
adding an additive to the microemulsion, said additive being a polymer including at least one hydrophobic unit and at least one water-soluble unit, a ratio of a number-average molecular weight of said at least one water-soluble unit of the additive to a corresponding number-average molecular weight of said at least one hydrophobic unit of the additive being in a range of 2 to 1000, each said at least one hydrophobic unit having a maximum molecular weight of 1000 g/mol.

47. A method according to claim 46, wherein said at least one hydrophobic unit is provided on at least one chain end of said additive or as a non-terminal substituent of said additive.

48. A method according to claim 46, wherein said at least one hydrophobic unit includes at least two hydrophobic units on at least one chain end of said additive.

49. A method according to claim 46, wherein:
said at least one water soluble unit includes water soluble units; and
said at least one hydrophobic unit is incorporated at least one location between the water-soluble units.

50. A method according to claim 46, wherein said at least one change includes an increase in efficiency of the surfactant.

51. A method according to claim 46, wherein said at least one change includes a broadening of a temperature window of the microemulsion.

52. A method according to claim 46, wherein said at least one change includes suppression of lamellar phases in the microemulsion.

53. A method according to claim 46, wherein the ratio of the number-average molecular weight of said at least one water-soluble unit of the additive to the corresponding number-average molecular weight of said at least one hydrophobic unit of the additive is in a range of 5 to 200.

54. A method according to claim 53, the ratio of the number-average molecular weight of said at least one water-soluble unit of the additive to the corresponding number-average molecular weight of said at least one hydrophobic unit of the additive is in a range of 10 to 50.

55. A method according to claim 46, wherein the number-average molecular weight of said at least one water-soluble unit of the additive is in a range of 500 to 100,000 g/mol.

56. A method according to claim 55, the number-average molecular weight of said at least one water-soluble unit of the additive is in a range of 2000 to 20,000 g/mol.

57. A method according to claim 56, the number-average molecular weight of said at least one water-soluble unit of the additive is in a range of 3000 to 10,000 g/mol.

58. A method according to claim 46, wherein the number-average molecular weight of said at least one hydrophobic unit of the additive is in a range of 80 and 1000 g/mol.

59. A method according to claim 58, wherein the number-average molecular weight of said at least one hydrophobic unit of the additive is in a range of 110 to 500 g/mol.

60. A method according to claim 59, wherein the number-average molecular weight of said at least one hydrophobic unit of the additive is in a range of 110 to 280 g/mol.

61. A method according to claim 46, wherein said at least one water-soluble unit of the additive is linear.

62. A method according to claim 46, wherein said at least one water-soluble unit of the additive is branched.

63. A method according to claim 46, wherein said at least one water-soluble unit of the additive is star-shaped.

64. A method according to claim 46, wherein said at least one water-soluble unit of the additive is non-ionic.

65. A method according to claim 46, wherein said at least one water-soluble unit of the additive is ionic.

66. A method according to claim 65, wherein said at least one water-soluble unit of the additive has at least two charges.

67. A method according to claim 46, wherein said at least one water-soluble unit of the additive includes an ionic and a non-ionic component.

68. A method according to claim 66, wherein said at least one water-soluble unit of the additive includes an ionic and a non-ionic component.

69. A method according to claim 46, wherein said at least one water-soluble unit of the additive comprises at least one component selected from the group of monomer components consisting of ethylene oxide, vinyl pyrrolidine, acrylic acid, methacrylic acid, maleic acid anhydride, and acrolein.

70. A method according to claim 46, wherein said at least one water-soluble component of the additive comprises at least one component selected from the group consisting of polyethylene oxide, polyethylene glycol, copolymerisates of ethylene oxide and propylene oxide, polyacrolein, polyvinyl alcohol and its water-soluble derivatives, polyvinyl pyrrolidone, polyvinyl pyridine, polymethacrylic acid, polymaleic acid anhydride, polymaleic acid, polyacrylic acid, polystyrene sulfonic acid and its water-soluble salts.

71. A method according to claim 46, wherein said at least one hydrophobic unit of the additive includes at least one alkyl group.

72. A method according to claim 71, wherein said at least one alkyl group includes 6 to 50 carbon atoms.

73. A method according to claim 72, wherein said at least one alkyl group includes 8 to 20 carbon atoms.

74. A method according to claim 46, wherein said at least one hydrophobic unit is unsaturated.

75. A method according to claim 74, wherein said at least one hydrophobic unit of the additive has an aromatic structure or is a structure with double bonds.

76. A method according to claim 71, wherein said at least one hydrophobic unit of the additive includes organic groups, comprising at least one component selected from the group of atoms consisting of oxygen, nitrogen, fluorine, chlorine, and silicon.

77. A method according to claim 74, wherein said at least one hydrophobic unit of the additive includes organic groups, comprising at least one component selected from the group of atoms consisting of oxygen, nitrogen, fluorine, chlorine, and silicon.

78. A method according to 46, wherein the additive is an alcohol ethoxylate comprising a monovalent alcohol having 8 to 20 carbon atoms and 25 to 500 ethylene oxide units.

79. A method according to claim 64, wherein the additive is an alcohol ethoxylate comprising a monovalent alcohol having 8 to 20 carbon atoms and 25 to 500 ethylene oxide units.

80. A method according to claim 69, wherein the additive is an alcohol ethoxylate comprising a monovalent alcohol having 8 to 20 carbon atoms and 25 to 500 ethylene oxide units.

81. A method according to claim 75, wherein the additive is an alcohol ethoxylate comprising a monovalent alcohol having 8 to 20 carbon atoms and 25 to 500 ethylene oxide units.

82. A method according to claim 46, wherein the ratio of the molecular weight of the water-soluble part to the molecular weight of the hydrophobic part is 5 to 200.

83. A microemulsion, comprising:
oil;
a surfactant; and
an additive, said additive being a polymer including at least one hydrophobic unit and at least one water-soluble unit, a ratio of a number-average molecular weight of said at least one water-soluble unit of the additive to a corresponding number-average molecular weight of said at least one hydrophobic unit of the additive being in a range of 2 to 1000, each said at least one hydrophobic unit having a maximum molecular weight of 1000 g/mol.

84. A microemulsion according to claim 83, wherein the number-average molecular weight of the at least one water-soluble unit of the additive is at least 5 times greater than the corresponding number-average molecular weight of the at least one hydrophilic unit of the surfactant.

85. A microemulsion according to claim 84, wherein the mean-average molecular weight of the at least one water-soluble unit of the additive is at least 10 times greater than the mean-average molecular weight of the at least one hydrophilic unit of the surfactant.

86. A microemulsion according to claim 83, wherein said microemulsion does not have a lamellar phase.

87. A microemulsion according to claim 83, wherein said microemulsion is bicontinuous.

88. A microemulsion according to claim 83, wherein a weight ratio of additive to surfactant+additive is ≦0.2 and the weight ratio of surfactant+polymer additive to oils is ≦0.5.

89. A microemulsion according to claim 88, wherein the weight ratio of additive to surfactant+additive is ≦0.15 or ≦0.10.

90. A microemulsion according to claim 88, wherein the weight ratio of surfactant+additive to oil is ≦0.33.

91. A microemulsion according to claim 83, wherein:
a weight ratio of additive to surfactant+additive is ≦0.2; and
the additive possesses one or more hydrophobic units at one location in the molecule.

92. A microemulsion according to claim 91, wherein the weight ratio of additive to surfactant+additive is ≦0.15 or ≦0.10.

93. A microemulsion according to claim 91, wherein the weight ratio of surfactant+additive to oil is ≦1.

94. A microemulsion according to claim 93, wherein the weight ratio of surfactant+additive to oil is ≦0.5, preferably ≦0.33.

95. A microemulsion according to claim 83, wherein said at least one hydrophobic unit is provided on at least one chain end of said additive or as a non-terminal substituent of said additive.

96. A microemulsion according to claim 95, wherein said at least one hydrophobic unit includes at least two hydrophobic units on at least one chain end of said additive.

97. A microemulsion according to claim 83, wherein:
said at least one water soluble unit includes water soluble units; and
said at least one hydrophobic unit is incorporated at least one location between the water-soluble units.

98. A microemulsion according to claim 83, wherein the ratio of the number-average molecular weight of said at least one water-soluble unit of the additive to the corresponding number-average molecular weight of said at least one hydrophobic unit of the additive is in a range of 5 to 200.

99. A microemulsion according to claim 98, the ratio of the number-average molecular weight of said at least one water-soluble unit of the additive to the corresponding number-average molecular weight of said at least one hydrophobic unit of the additive is in a range of 10 to 50.

100. A microemulsion according to claim 83, wherein the number-average molecular weight of said at least one water-soluble unit of the additive is in a range of 500 to 100,000 g/mol.

101. A microemulsion according to claim 100, the number-average molecular weight of said at least one water-soluble unit of the additive is in a range of 2000 to 20,000 g/mol.

102. A microemulsion according to claim 101, the number-average molecular weight of said at least one water-soluble unit of the additive is in a range of 3000 to 10,000 g/mol.

103. A microemulsion according to claim 83, wherein the number-average molecular weight of said at least one hydrophobic unit of the additive is in a range of 80 and 1000 g/mol.

104. A microemulsion according to claim 103, wherein the number-average molecular weight of said at least one hydrophobic unit of the additive is in a range of 110 to 500 g/mol.

105. A microemulsion according to claim 104, wherein the number-average molecular weight of said at least one hydrophobic unit of the additive is in a range of 110 to 280 g/mol.

106. A microemulsion according to claim 83, wherein said at least one water-soluble unit of the additive is linear.

107. A microemulsion according to claim 83, wherein said at least one water-soluble unit of the additive is branched.

108. A microemulsion according to claim 83, wherein said at least one water-soluble unit of the additive is star-shaped.

109. A microemulsion according to claim 83, wherein said at least one water-soluble unit of the additive is non-ionic.

110. A microemulsion according to claim 83, wherein said at least one water-soluble unit of the additive is ionic.

111. A microemulsion according to claim 110, wherein said at least one water-soluble unit of the additive has at least two charges.

112. A microemulsion according to claim 83, wherein said at least one water-soluble unit of the additive includes an ionic and a non-ionic component.

113. A microemulsion according to claim 111, wherein said at least one water-soluble unit of the additive includes an ionic and a non-ionic component.

114. A microemulsion according to claim 92, wherein said at least one water-soluble unit of the additive comprises at least one component selected from the group of monomer components consisting of ethylene oxide, vinyl pyrrolidine, acrylic acid, methacrylic acid, maleic acid anhydride, and acrolein.

115. A microemulsion according to claim 83, wherein said at least one water-soluble component of the additive comprises at least one component selected from the group consisting of polyethylene oxide, polyethylene glycol, copolymerisates of ethylene oxide and propylene oxide, polyacrolein, polyvinyl alcohol and its water-soluble derivatives, polyvinyl pyrrolidone, polyvinyl pyridine, polymethacrylic acid, polymaleic acid anhydride, polymaleic acid, polyacrylic acid, polystyrene sulfonic acid and its water-soluble salts.

116. A microemulsion according to claim 83, wherein said at least one hydrophobic unit of the additive includes at least one alkyl group.

117. A microemulsion according to claim 116, wherein said at least one alkyl group includes 6 to 50 carbon atoms.

118. A microemulsion according to claim 117, wherein said at least one alkyl group includes 8 to 20 carbon atoms.

119. A microemulsion according to claim 83, wherein said at least one hydrophobic unit is unsaturated.

120. A microemulsion according to claim 119, wherein said at least one hydrophobic unit of the additive has an aromatic structure or is a structure with double bonds.

121. A microemulsion according to claim 116, wherein said at least one hydrophobic unit of the additive includes organic groups, comprising at least one component selected from the group of atoms consisting of oxygen, nitrogen, fluorine, chlorine, and silicon.

122. A microemulsion according to claim 119, wherein said at least one hydrophobic unit of the additive includes organic groups, comprising at least one component selected from the group of atoms consisting of oxygen, nitrogen, fluorine, chlorine, and silicon.

123. A microemulsion according to 83, wherein the additive is an alcohol ethoxylate comprising a monovalent alcohol having 8 to 20 carbon atoms and 25 to 500 ethylene oxide units.

124. A microemulsion according to claim 109, wherein the additive is an alcohol ethoxylate comprising a monovalent alcohol having 8 to 20 carbon atoms and 25 to 500 ethylene oxide units.

125. A microemulsion according to claim 114, wherein the additive is an alcohol ethoxylate comprising a monovalent alcohol having 8 to 20 carbon atoms and 25 to 500 ethylene oxide units.

126. A microemulsion according to claim 120, wherein the additive is an alcohol ethoxylate comprising a monovalent alcohol having 8 to 20 carbon atoms and 25 to 500 ethylene oxide units.

127. A microemulsion according to claim 83, wherein the ratio of the molecular weight of the water-soluble part to the molecular weight of the hydrophobic part is 5 to 200.
